(19) United States
(12) Patent Application Publication
(10) Pub. No.: US 2013/0304447 A1
(43) Pub. Date: Nov. 14, 2013

(54) Spike-timing computer modeling of working memory

(71) Applicant: NEUROSCIENCES RESEARCH FOUNDATION, INC., La Jolla, CA (US)

(72) Inventors: Botond Szatmáry, Del Mar, CA (US); Eugene Izhikevich, San Diego, CA (US)

(21) Appl. No.: 13/987,173

(22) Filed: Jul. 8, 2013

Related U.S. Application Data
(63) Continuation of application No. 13/066,027, filed on Apr. 5, 2011, now abandoned.
(60) Provisional application No. 61/341,997, filed on Apr. 8, 2010.

(51) Int. Cl. G06F 19/12

(52) U.S. Cl. CPC G06F 19/12
USPC 703/11

(57) ABSTRACT

Working memory (WM) is part of the brain's memory system that provides temporary storage and manipulation of information necessary for cognition. Although WM has limited capacity at any given time, it has vast memory content in the sense that it acts on the brain's nearly infinite repertoire of lifetime memories. As described, large memory content and WM functionality emerge spontaneously if the spike-timing nature of neuronal processing is taken into account. The memories are represented by extensively overlapping groups of neurons that exhibit stereotypical time-locked spatiotemporal spike-timing patterns, called polychronous patterns. Using computer-implemented simulations, associative synaptic plasticity in the form of short-term STDP selects such polychronous neuronal groups (PNGs) into WM by temporarily strengthening the synapses of the selected PNGs. This strengthening increases the spontaneous reactivation frequency of the selected PNGs, resulting in irregular, yet systematically changing elevated firing activity patterns consistent with those recorded in vivo during WM tasks. The computer-implemented model implements the relationship between such slowly changing firing rates and precisely timed spikes, and also reveals a novel relationship between WM and the perception of time on the order of seconds.

### CLAIM OF PRIORITY

This application claims priority to U.S. patent application Ser. No. 13/066,027 entitled “SPIKE-TIMING COMPUTER MODELING OF WORKING MEMORY” by Szatmáry, et al., filed Apr. 5, 2011 and to U.S. Provisional Application No. 61/341,997 entitled “SPIKE-TIMING COMPUTER MODELING OF WORKING MEMORY”, by Szatmáry, et al., filed Apr. 8, 2010, which application is incorporated herein by reference.

### STATEMENT REGARDING FEDERALLY SPONSORED RESEARCH AND DEVELOPMENT

Statement Regarding Federally Sponsored Research and Development: This invention was made with Government support under grant N00014-08-1-0728 awarded by the Office of Naval Research. The United States Government has certain rights in the invention.

### FIELD OF THE INVENTION

The present invention relates to an aspect of the human brain known as working memory (WM), and more specifically, to a computer based model for implementing working memory.

### BACKGROUND OF THE INVENTION

Working memory (WM) is the part of the human brain's vast memory system that provides temporary storage and manipulation of the information necessary for complex cognitive tasks, such as language comprehension, learning and reasoning. In a working memory WM task, attention is focused on the internal representation of a briefly presented external cue that must be held in working memory WM to guide the forthcoming response. During this delay period from the onset of the external cue to the time of the response by the working memory WM, elevated firing activity or firing rate of the neurons participating in the representation of the external cue is often observed; for example, as in the prefrontal cortex of the brain.

Various mechanisms have been previously proposed to model sustained elevated firing rates. Despite extensive neuroscience research, however, its mechanism is not clearly understood. These mechanisms include (i) reentrant spiking activity, (ii) NMDA (N-methyl-d-asparate) currents, (iii) short-term synaptic plasticity, and (iv) intrinsic membrane currents. Such mechanisms, however, fail to explain other aspects of neural correlates of working memory WM, and they have been demonstrated to work only with a limited memory content. Memories in the simulated networks are often represented by carefully selected, largely non-overlapping groups of spiking neurons. Indeed, extending the memory content in such networks increases the overlap between the memory representations (unless the size of the network is increased, too) and activations of one representation spreads to others resulting in uncontrollable epileptic-like “runaway excitation”. The narrow memory content, however, is at odds with experimental findings that neurons participate in many different neural circuits and, therefore, are part of many distinct representations that form a vast memory content for working memory WM.

### BRIEF SUMMARY OF THE INVENTION

The above-described limitation arises because none of the previous approaches have taken the spike-timing nature of neural processing into account. Precise spike timing, however, is crucial to form large memory content, as described below.

Memories therefore, in accordance with the present invention, are represented by extensively overlapping neuronal groups that exhibit stereotypical time-locked but not necessarily synchronous firing patterns, called polychronous patterns. Distinct patterns of synaptic connections with appropriate axonal conduction delays form distinct polychronous neuronal groups (PNGs). These polychronous neuronal groups PNGs are defined by distinct patterns of synapses, and not by the neurons per se, which allows the neurons to take part in multiple PNGs and enables the same set of neurons to generate distinct stereotypical time-locked spatiotemporal spike-timing patterns. Such PNGs arise spontaneously in simulated realistic cortical spiking networks shaped by spike-timing dependent plasticity (STDP).

Another distinct feature of the present invention is that synaptic efficacies are subject to associative short-term changes, that is, changes that depend on the conjunction of pre- and post-synaptic activity. Two different mechanisms are described below: associative short-term synaptic plasticity via short-term STDP, and the short-term amplification of synaptic responses via simulated NMDA spikes at corresponding dendritic sites. The exact form of such short-term synaptic changes is not important for WM functionality, as long as the changes selectively affect synapses depending on the relative spike-timing patters of pre- and post-synaptic neurons. For example, activation of one PNG temporarily potentiates synapses in that one group and not the synapses in another PNG. This differs from the standard short-term synaptic facilitation or augmentation used in other WM models, which are not associative, and hence non-selectively affect all synapses belonging to the same presynaptic neuron.

In the present invention, PNGs get spontaneously reactivated due to stochastic synaptic noise. These reactivations can be biased by short-term strengthening of the synapses of a selected PNG, which results in activity patterns similar to those observed in vivo during WM tasks. Additionally, despite that PNGs share neurons among each other, activity of one PNG does not spread to the others; therefore frequent reactivation of a selected PNG does not initiate uncontrollable activity in the network. Hence, the WM mechanism of the present invention can work in a network with large memory content.

### BRIEF DESCRIPTION OF THE DRAWING(S)

The patent or application file contains at least one drawing executed in color. Copies of this patent or patent application publication with color drawing(s) will be provided by the Office upon request and payment of the necessary fee.

FIG. 1A illustrates polychronous neuronal groups (PNGs) and associative short-term plasticity of neurons in the groups.

FIG. 1B illustrates one of the polychronous neuronal groups (PNGs) of FIG. 1A in which a neuron n1 fires first followed by the firing of a neuron n2.

FIG. 1C illustrates the other of the polychronous neuronal groups (PNGs) of FIG. 1A in which neuron n2 fires first followed by the firing of neuron n1.

FIGS. 2A-2C illustrates synaptic change due to associative short-term plasticity implemented in a form of short-term STDP, in dependence on the firing patterns of pre- and post-neurons.

FIG. 3A is a schematic diagram showing a multi-compartmental post-synaptic neuron receiving a synapse from a pre-synaptic neuron.

FIG. 3B shows a train of pre-synaptic spikes followed by a post-synaptic delayed response and caused by other synaptic inputs.

FIG. 3C illustrates excitatory post-synaptic potentials at a dendritic compartment.

FIG. 4A is a graph showing the number of emerging distinct PNGs for the simulations shown in FIG. 5A and FIG. 10A.

FIG. 4B is a graph showing the average duration of the PNGs of FIG. 4A.

FIG. 4C is a graph illustrating the number, on average, of neurons shared by each PNG of FIG. 4A.

FIG. 4D illustrates the distribution of frequency of activation of PNGs in simulated and surrogate (inverted time) spike trains.

FIGS. 4E and 4F show the participation of each neuron in different PNGs.

FIG. 5A illustrates graphically the spike timing nature of the PNGs of FIG. 1A.

FIG. 5B illustrates magnified spike raster reactivation firings of a target tPNG at two different times.

FIG. 5C shows cross-correlograms of two neurons in the tPNG under two different conditions.

FIG. 5D is a histogram of over 70 trials of three representative neurons that are part of the tPGN while it is in working memory (WM).

FIG. 5E is a histogram of the duration of PNGs loaded separately in working memory (WM).

FIG. 6 is a chart showing maintenance of a polychronous neuronal group (PNG) in working memory (WM) with short-term application of synaptic responses via NMDA spikes.

FIG. 7A illustrates spike raster and firing rate plots during a simple working memory (WM) trial simulation using an elevated level of neuromodulation over two respective intervals.

FIGS. 7B and 7C, respectively, are subplots of the second interval of FIG. 7A showing data for the neurons in the target groups tPNG.

FIG. 8 is an illustration of short-term synaptic plasticity change during memory replay overlaid on the spike raster chart of FIG. 7A.

FIGS. 9A-9E are charts used to explain how working memory (WM) improves the formation of new PNGs.

FIG. 10A illustrates graphically the spike timing raster and firing plots of a first target t₁PNG and a second target t₂PNG.

FIG. 10B is a plot of the number of randomly selected PNGs that were stimulated vs. the number of simultaneously coexisting PNGs in working memory (WM).

FIG. 10C is a magnified plot of the spike rasters of partial activation of two PNGs.

FIG. 10D is cross-correlograms, respectively, of two neurons under different respective conditions of working memory (WM).

FIG. 11 shows the maintenance by stimulation of multiple representations in working memory (WM) in a network of embedded PNGs.

FIGS. 12A-12E are used to explain the results of systematically changing persistent firing rates during working memory tasks.

### DETAILED DESCRIPTION OF THE DRAWINGS

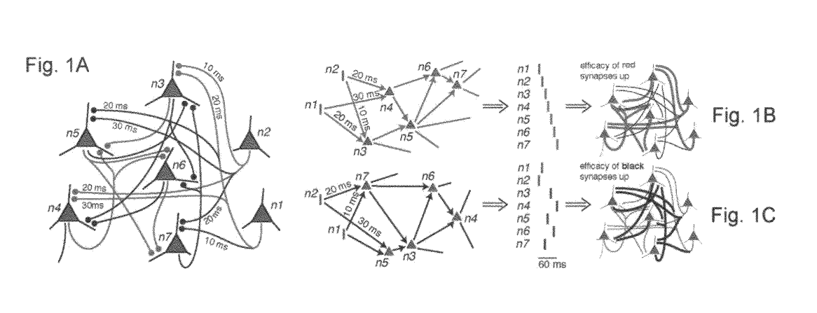

FIGS. 1A-1C are illustrations of exemplary polychronous neuronal groups (PNGs) of neurons n1-n7 and associative short-term plasticity. In FIG. 1A, synaptic connections between neurons n1, n2, . . . , n7 have different axonal conduction delays arranged such that the network forms two functional subnetworks, red and black, corresponding to two distinct PNGs, consisting of the same neurons. Spontaneous firing of neurons n1 and n2, e.g., due to either external stimulation or noisy non-specific synaptic input from other sources, can trigger the whole red PNG or black PNG. As shown in FIG. 1B, if neuron n1 fires followed by neuron n2 10 ms later, then the spiking activity will start propagating along the red subnetwork, resulting in the precisely timed firing sequence of neurons n3, n4, n5, n6, n7, and in the short-term potentiation of the red synapses. Post-synaptic neurons (not shown) that receive weak connections from neurons n3, n4, and n5 with long delays and from neurons n6 and n7 with shorter delays (or, alternatively, briefly excited by the activity of the former and slowly inhibited by the latter) will fire selectively when the red polychronous pattern PNG is activated, and hence serves as an appropriate readout of the red subnetwork. As shown in FIG. 1C, if neurons n2 and n1 fire with reversed order with the appropriate timings, activity will propagate along the black subnetwork making the same set of neurons fire but in a different order: n7, n5, n3, n6, n4, which temporarily strengthens the black synapses.

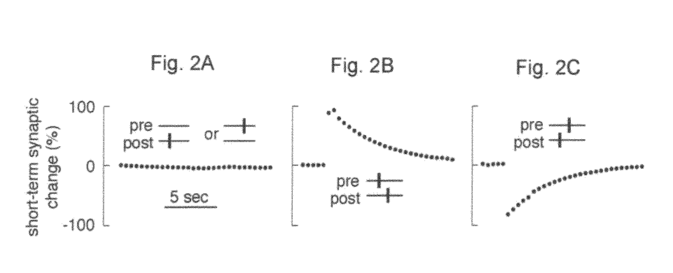

Thus, FIGS. 1A-1C show a small, exemplary network to illustrate how the same set of neurons n1-n7 can form two PNGs, i.e., how the neurons can execute two distinct temporal firing patterns through two sets of synaptic connections with appropriate axonal conduction delays (red and black connections in FIGS. 1A-1C). In both PNGs, each neuron n1-n7 fires only once, and the identity of the PNG is determined by the relative timings of spikes (see FIGS. 2A-2C below), which are defined by the intragroup connectivity. Activity of a given PNG can be read out by post-synaptic neurons (or circuits) (not shown) with appropriate connections. Since the PNGs shown in FIGS. 1A-1C are defined by the intragroup connectivity and not necessarily by the identity of the intragroup neurons n1-n7, the (i) known synaptic connections, (ii) conductance delays, and (iii) synaptic strength in computer simulated networks are used to count all the distinct PNGs.

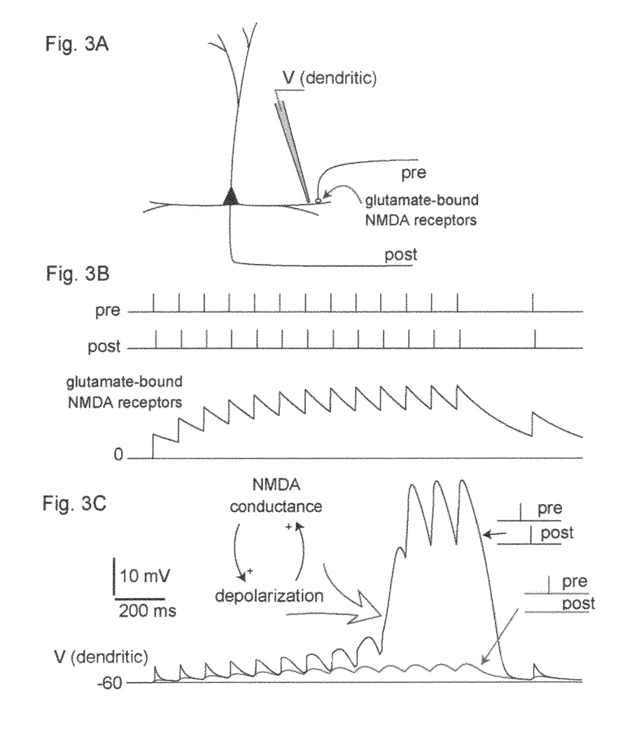

Synaptic efficacies are subject to associative short-term changes, that is, changes that depend on the conjunction of pre- and post-synaptic activity. Two different mechanisms are (1) associative short-term synaptic plasticity via short-term STDP (described more fully below in FIGS. 2A-2C), and (ii) the activation of simulated NMDA channels at the corresponding dendritic sites (see FIGS. 3A-3C below). The exact form of such short-term synaptic changes is not important for working memory WM functionality, as long as the changes selectively affect synapses depending on the relative spike-timing patterns of pre- and post-synaptic neurons. For example, activation of the red PNG in FIGS. 1A-1C temporarily potentiates red synapses and not black ones. This differs from the standard or prior short-term synaptic facilitation or augmentation used in prior working memory WM models, which are not associative, and hence non-selectively affect all synapses belonging to the same presynaptic neuron n1-n7.

Associative short-term plasticity, as mentioned above, is implemented in a form of short-term-STDP. A synaptic change is triggered by the classical STDP protocol but the change decays to 0 within a few seconds. FIG. 2A shows that firing of only pre- or post-synaptic neurons does not trigger any synaptic change. FIG. 2B illustrates that firing in the order pre-before-post induces short-term synaptic augmentation. On the other hand, FIG. 2C shows that the firing of the post-before-pre results in short-term synaptic depression.

FIGS. 3A-3C are schematic diagrams illustrating short-term amplification of synaptic responses via simulated NMDA receptors resulting in NMDA spikes. FIG. 3A shows a multi-compartmental neuron (post) receiving a synapse from a pre-synaptic neuron (pre). FIG. 3B illustrates a train of presynaptic spikes followed by a postsynaptic response delayed by 10 ms and caused by other synaptic inputs. Each pre-synaptic spike activates postsynaptic NMDA receptors and deactivates with a time constant of 250 ms.

FIG. 3C shows that excitatory postsynaptic potentials at the dendritic compartment are small [black trace V (dendritic)] because of the simulated magnesium block of the NMDA receptors. As the pre-then-post train of action potentials persist, the dendritic membrane potential depolarizes, the magnesium block is removed, and the positive-feedback regenerative process flips the dendritic compartment into the up-state. While in the up-state, each pre-synaptic spike results in a large-amplitude response (often called NMDA spike) that can propagate to the soma and enhance the efficacy of the synaptic transmission in eliciting a somatic spike. The red trace of FIG. 3C shows the control simulation when the post-synaptic spikes are absent. No significant increase in synaptic efficacy is observed in this case.

The voltage traces shown in FIG. 3C are simulations of a passive dendritic compartment with voltage-dependent NMDA conductance. Parameters: C=100 pF, Eₗₑₐₖ=−60 mV, gₗₑₐₖ=10 nS, τ_{NMDA}=250 ms, E_{NMDA}=55 mV; The voltage dependence of NMDA conductance is described by the nonlinear function g(x)=x²/(1+x²) if x≧0 and g(x)=0 if x<0, where x=(V+65)/60 and V is the dendritic membrane potential.

There will now be described a specific, but exemplary, computer-modeled simulation of working memory WM. A brief description of the simulation will be given with general reference to the drawings. This will be followed by a more detailed description of the drawings and the simulations.

Network:

The network consists of n=1000 simulated spiking neurons n (1): 80% pyramidal neurons of regular spiking type, 20% GABAergic interneurons of fast spiking type. The probability that any pair of neurons n are connected equals 0.1. Synaptic connections have a random distribution of axonal conduction delays in the [0 . . . 20] ms range (2). Synaptic efficacy is subject to both short-term plasticity (mentioned above and detailed in the Short-term synaptic plasticity section below) and long-term plasticity (regular spike-timing dependent plasticity). Maximum synaptic strengths are set so that at least 2.5 simultaneously arriving pre-synaptic spikes are needed to elicit a post-synaptic spike.

Polychronous Groups (PNGs):

Polychronous neuronal groups (PNGs) are defined by the intragroup synaptic connectivity and not necessarily by the intragroup neurons (as already described and as illustrated in FIGS. 1A-1C). PNGs spontaneously emerge in spiking networks with synaptic conductance delays. Specified network data, i.e. synaptic connections, conductance delays, and strengths, are used to count all the PNGs in a network. Since each group PNG generates a distinct pattern of stereotypical spiking activity, this pattern is used to find the reactivation of a given PNG embedded in the spike train. A PNG is said to activate when more than 25 percent of its neurons polychronize, that is, fire according to the prescribed spike-timing pattern with ±15 ms jitter.

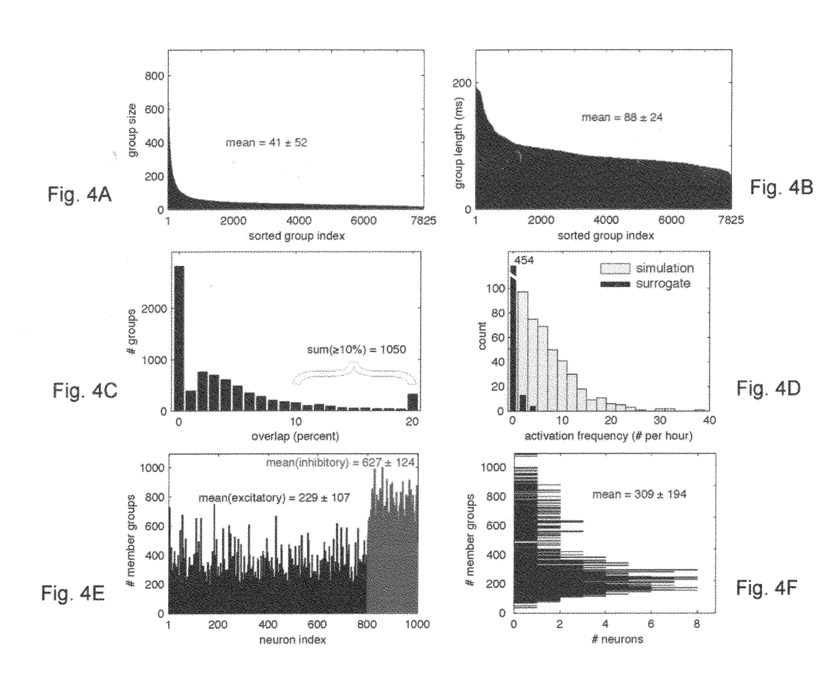

After running a simulation for five hours, providing only non-specific noisy input to the network, the evolved synaptic connectivity was analyzed and a total of N=7825 spontaneously generated distinct PNGs were found, as shown in FIG. 4A. On average, a PNG consists of 41 neurons (see FIG. 4A), and any two PNGs share 5% of their neurons. Each PNG shares at least ten neurons with about a thousand other groups, and each neuron participates in 309±193 different groups (see FIG. 4F).

Input to the Network

Non-Specific Input:

Throughout the simulation, the network of neurons is stimulated with stochastic miniature synaptic potentials, and it exhibits asynchronous noisy spiking activity, with an average firing rate around 0.3 Hz.

Specific Input:

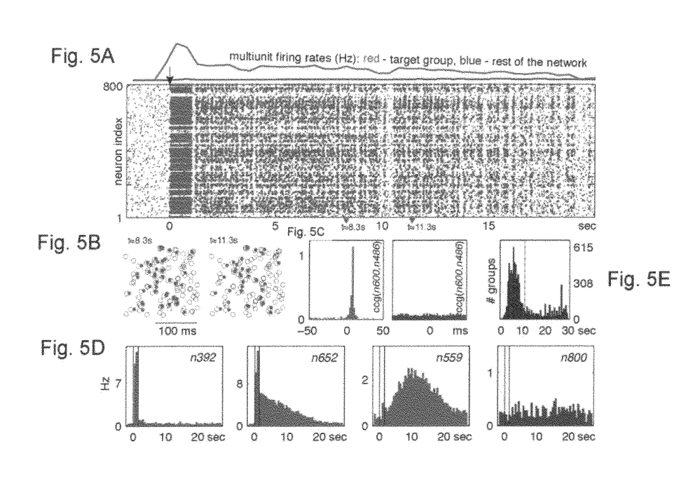

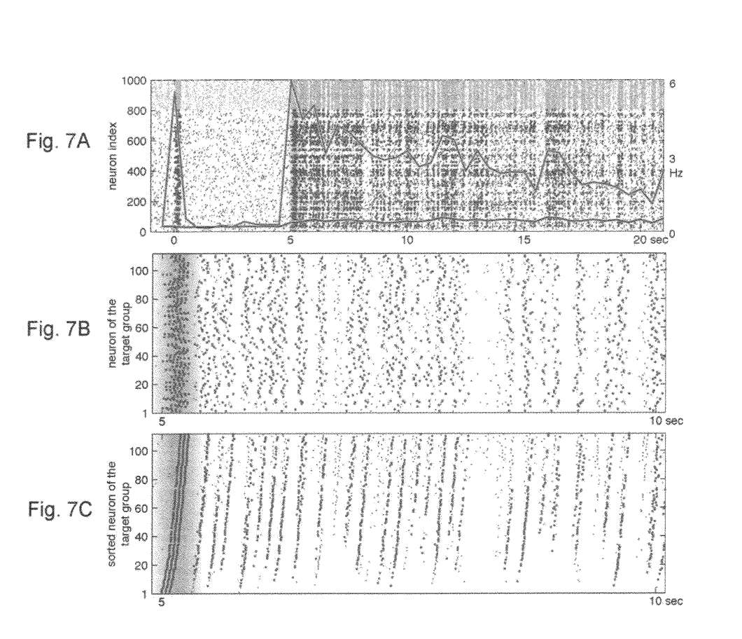

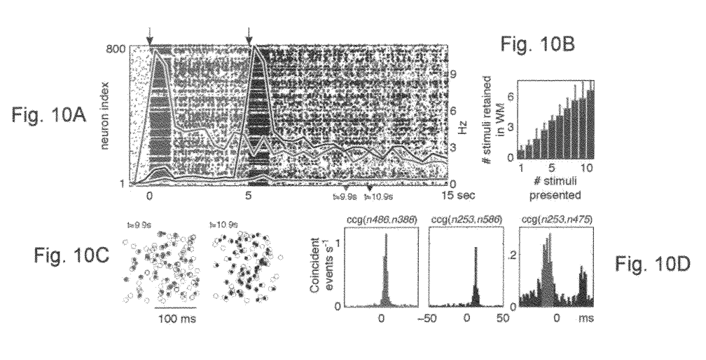

To select one specific group PNG of neurons in working memory WM, its neurons are stimulated transiently sequentially with the appropriate spatiotemporal polychronous pattern, as seen in FIG. 5A and FIG. 10A. What emerges in working memory WM is gated by attention, for which two different implementations are provided:
Strong excitatory drive (as seen in FIGS. 5A-5E and FIGS. 10A-10D). The intragroup neurons are stimulated sequentially with an appropriate polychronous pattern ten times during a one second interval to temporarily increase the intragroup synaptic efficacy.
Incorporate a faster rate of synaptic plasticity modulated by simulated elevated levels of a neural modulator, e.g., dopamine, (as shown in FIGS. 7A-7C). Stochastic stimulation is used so that the firing response probability of individual neurons n is smaller then 1. Intragroup neurons n are stimulated sequentially with the appropriate polychronous pattern one to three times during a short interval of a few hundred milliseconds when the level of the extracellular simulated neural modulator, e.g. dopamine, in the network is high. This stimulation mechanism results in a five-fold faster rate of change of synaptic plasticity. As is known, dopaminergic regulation of prefrontal cortex activity is essential for cognitive functions such as working memory WM. The elevated neuromodulator level increases the level of sensitivity of the working memory WM to the current stimulus.

Short-Term Synaptic Plasticity:

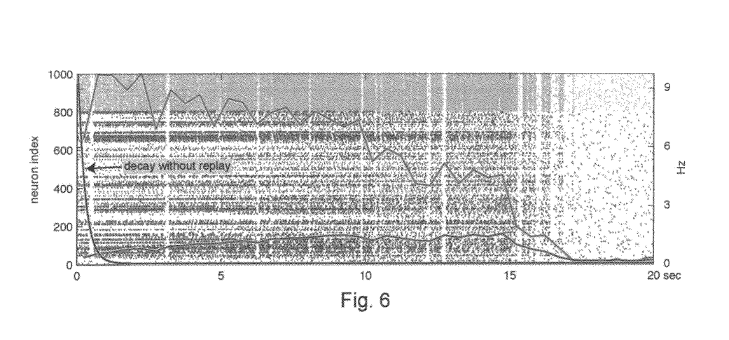

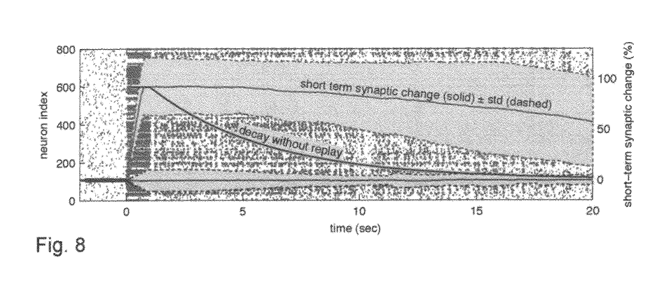

There are two different mechanisms for short-term synaptic plasticity: (i) associative short-term synaptic plasticity via short-term STDP, and (ii) the activation of simulated NMDA receptors at the corresponding dendritic sites, as described above. The exact form of such short-term synaptic changes is not important, so long as the change selectively affecting synapses depends on the relative spike-timing patterns of pre- and post-synaptic neurons. FIGS. 2A-2B and FIG. 8 detail the associative short-term synaptic plasticity mechanism. FIGS. 3A-3C and FIG. 6 demonstrate short-term amplification of synaptic responses via NMDA spikes.

Novel Stimulus—Working Memory Extends Memory Capacity:

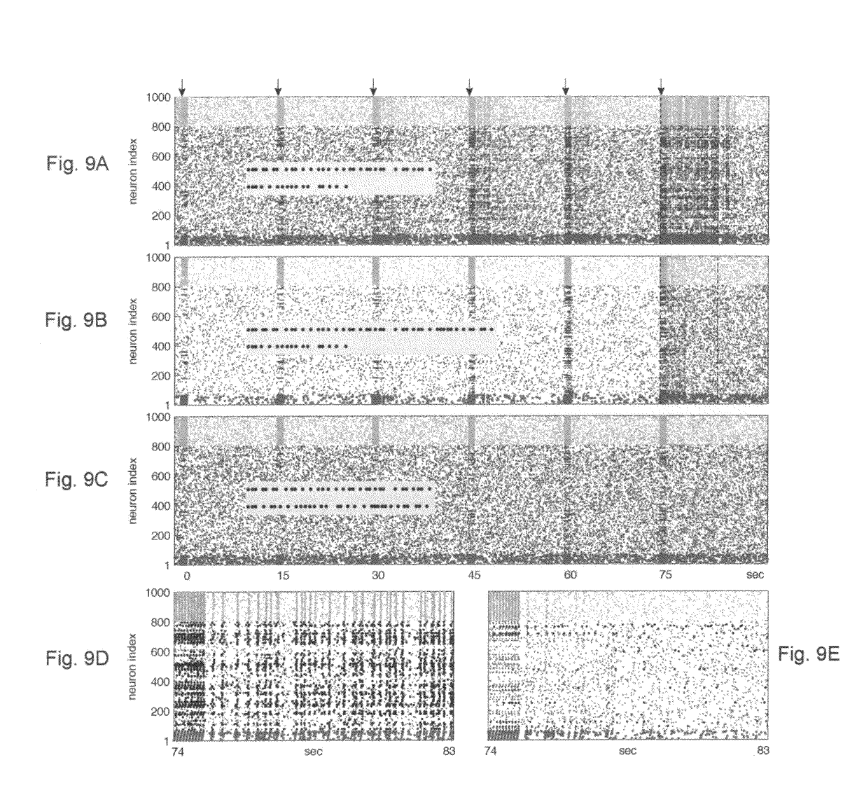

Short-term plasticity and working memory WM increase the repertoire of PNGs. Each time a novel spatiotemporal stimulus is presented to the network of 1000 neurons, the synapses between the stimulated neurons that fire with the appropriate order are potentiated due to long-term STDP. In addition, synapses to some other post-synaptic neurons that were firing by chance and have synaptic connections with converging conduction delays that support appropriate spike timing, are also potentiated. Thus, the formation of a new group PNG occurs when neurons fire repeatedly with the right spatiotemporal pattern. The pattern can be triggered by stimulation, or it could result from autonomous reactivations due to working memory WM. The effect of working memory WM on the size of the repertoire of PNGs is shown by stimulation of the network with a novel spike-timing pattern every 15 seconds (see FIG. 9A). This unique polychronous pattern used for stimulation does not correspond to the firing pattern of any of the existing polychronous neuronal groups PNGs. As controls, spontaneous replay of the unique pattern is prevented by reducing the frequencies of noisy minis or by blocking short-term plasticity (see FIGS. 9B-9C). When tested, replay enhanced the formation of a novel PNG (see FIGS. 9D-9E).

Inserted Polychronous Structure:

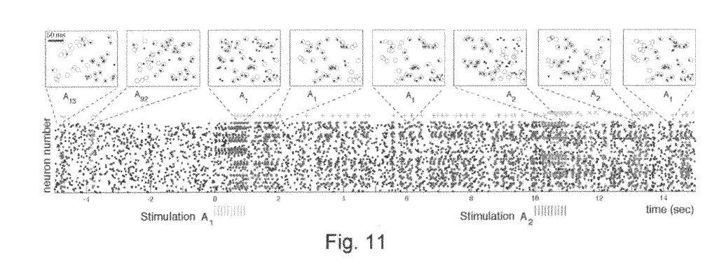

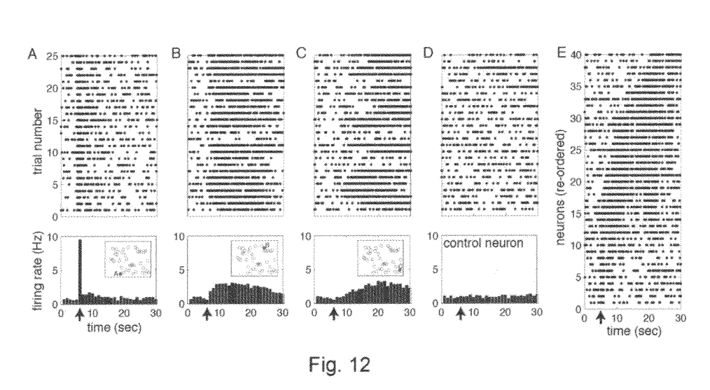

The robustness of the working memory WM simulations with respect to a given choice of target PNG is shown in FIG. 11 and FIGS. 12A-12E. Multiple spontaneously emerging groups PNGs can be selected and held in working memory WM (see FIGS. 5A-5E and FIGS. 10A-10D). In FIG. 11 and FIGS. 12A-12E, the results of FIGS. 5A-5E and FIGS. 10A-10D are replicated using polychronous groups PNGs that are manually generated and inserted in the network. That is, additional synapses in the randomly connected network in order to form 100 polychronous groups PNG are inserted into the network. Activity of each group PNG lasted for 200 milliseconds and it consisted of 40 neurons. Each intragroup neuron has at least three converging synapses from other pre-synaptic intragroup neurons (except for the first three neurons in the group).

There will now be described more detailed aspects of the computer simulation with more specific reference to the drawings.

FIGS. 4A-4F: Properties of Polychronous Neuronal Groups.

(FIG. 4A) The number of emerging distinct PNGs, N=7825 for the simulation. On average, a PNG consists of 41 neurons. (FIG. 4B) The average duration is 88 milliseconds. (FIG. 4C) Each PNG shares at least 10 neurons n, on average, with 1050 other groups and 5% of neurons n of any particular group are shared with any other group in the network (not shown). (FIG. 4D) Distribution of frequencies of activation of PNGs in the simulated and surrogate (inverted time) spike trains. Surrogate data emphasize the statistical significance of these events. (FIGS. 4E-4F) Each neuron n participates in 309±193 different groups.

FIGS. 5A-5E. Maintenance of a PNG in Working Memory WM—Spike Timing Nature of WM—A “Cue” in Working Memory.

(FIG. 5A) Spike raster of a single trial: Blue dots, firing of all excitatory neurons n in the network (inhibitory neurons not shown); Red dots, spikes of the neurons n belonging to the selected target PNG (tPNG) during reactivations of the tPNG, that is, when more than 25% of its neurons fire with the expected spatiotemporal pattern (with ±15 ms jitter). Neurons n of the tPNG are stimulated with the appropriate spike-timing pattern at t=0 seconds (to be loaded into working memory WM). The initiation of working memory WM is gated by attention. Two different mechanisms are demonstrated: strong excitatory drive (arrow) or shorter/weaker stimulation along with modulation of plasticity rate by a simulated neuromodulator, e.g., extracellular dopamine. Both mechanisms lead to similar results. Solid lines above-average multiunit firing rate of the tPNG (red) and that of the rest of the excitatory neurons (blue). (FIG. 5B) Magnified spike rasters of two partial reactivations of the tPNG neurons at two different times: Red dots, spikes of tPNG neurons; Circles, expected firings of all neurons in the tPNG. (FIG. 5C) Cross-correlograms of two neurons in the tPNG under two different conditions: Red, tPNG in WM; Blue, spontaneous network activity (spike raster not shown). (FIG. 5D) Average firing rate histogram (over 70 trials) of three representative neurons (red) that are part of the tPNG while it is in working memory WM, and a control neuron (blue) from the rest of the network. (FIG. 5E) Histogram of the duration of PNGs loaded separately in working memory WM: time of the last reactivation (after the offset of stimulation) of each PNG versus number of PNGs with a given maximum reactivation span.

More particularly, to initiate sustained neuronal activity that characterizes WM, a random PNG is selected, or cued, and its neurons are then stimulated in the sequence that characterizes the PNG's polychronous pattern. The red dots in the spike raster in FIG. 5A indicate spikes of the selected target PNG. The initial stimulation of the target PNG results in short-term strengthening of the intra-PNG synapses via associative shortterm plasticity, and has little effect on the other synapses in the network (see discussion below of FIG. 8). Upon termination of the stimulation, the temporarily facilitated intra-PNG synapses and the noisy synaptic inputs result in sporadic reactivations of different segments of the target PNG, often leading to the activation of the rest of the polychronous sequence (seen as red vertical stripes in the raster in FIG. 5A and magnified in FIGS. 5B and 7C). Each such reactivation of the target PNG triggers further strengthening of its synapses, thereby maintaining the target PNG in the active state for tens of seconds. Note that the active maintenance of a PNG in WM does not depend on a reverberant/looping circuit; it emerges as a result of the interplay between non-specific noise (which spontaneously triggers activation of PNGs) and short-term strengthening of the appropriate synapses (that makes subsequent reactivations of the target PNG more likely). There are frequent gaps of hundreds of milliseconds between spontaneous reactivations of the target PNG, clearly seen in FIG. 1A, but occasional reactivation is necessary to maintain the PNG in WM. Without the reactivations, the initial short-term strengthening of intra-PNG synapses decays quickly (FIGS. 6 and 8, “decay without replay” curves). FIG. 5E shows that almost all of the thousands of emerged PNGs, if stimulated, remained activated for more than ten seconds in WM (average 11±8 seconds).

Novel Stimulus—Working Memory Expands Memory Content

A novel cue can be loaded and kept in WM, by stimulating the network with a novel spike-timing pattern repeatedly every 15 seconds (FIG. 9A). Note that this spiking pattern—triggered by the novel external cue—does not correspond to any of the existing PNGs' firing patterns. Each time the new pattern is presented to the network, the synapses between the stimulated neurons that fire with the appropriate order are potentiated due to long-term STDP. In addition, synapses to some other post-synaptic neurons that were firing by chance and have synaptic connections with converging conduction delays that support appropriate spike timing, are also potentiated. Thus, the expansion of the network's memory content, i.e., the formation of a new PNG representing the novel cue, occurs via the interplay of long-term STDP and repeated firing of neurons with the right spatiotemporal pattern. The pattern may be triggered by stimulation, or it may result from autonomous reactivations due to working memory (FIG. 9A), therefore, the WM mechanism, by facilitating the reactivations, facilitates the formation of the new PNG (FIGS. 9A-9E). Despite that the new PNG consists both of neurons that received and of neurons that did not receive direct stimulation during the cue presentations/learning, in order to load and keep the cue in WM it is sufficient to stimulate those neurons that were directly stimulated during learning (FIGS. 9A-9D). Reactivation frequency of the new PNG, 4 Hz, is similar to those observed in FIGS. 5 and 10.

Precise Spike-Timing and Functional Connectivity Changes During Working Memory Maintenance

Since spontaneous reactivations of the target PNG in WM are stochastic, timing of the spiking activity of each neuron in a PNG also looks random when considered in isolation. Preserved intra-PNG timing at the millisecond timescale is, however, maintained during replay, as can be seen in the magnified spike rasters in FIGS. 5B, 7C and 10C. This feature distinguishes the approach of the present invention from earlier approaches that posit synchronous or totally asynchronous spiking, and this feature allows the computer model of the present invention to have a vast repertoire of overlapping PNGs, i.e., large memory content. Cross-correlograms (CCG) of simulated intra-PNG neuronal pairs also reveal the precisely timed nature of their spiking activity, as well as the context-dependent changes in functional connectivity linking these neurons: The red CCG in FIG. 5C is recorded while the target PNG is in WM, and it has a peak around 5 ms, whereas the blue CCG is recorded later in a different session, when the PNG is not activated, and it is flat. (A similar dependence of CCGs of spiking activity on the behavioral state of the network biased by sensory cues is known to occur in medial prefrontal neurons.)

Systematically Varying Persistent Firing Activity

The average multiunit firing rate of the neurons forming the target PNG following activation is around 4 Hz, much higher than that of the rest of the network, which is about 0.3 Hz (FIG. 5A, red vs. blue solid lines). The average firing rate histograms of most intra-PNG neurons show distinct temporal profiles that repeat from trial to trial (FIGS. 5D and 12): Some neurons only respond to the initial stimulation (FIG. 5D n392); some have ramping or decaying firing rates (n652); whereas others have their peak activity seconds after the stimulus offset (n559). Neurons that are not part of the target PNG show uniform low firing rate activity across the whole trial (n800). These systematically varying, persistent temporal firing profiles are similar to those observed experimentally in vivo in the frontal cortex during the delay period of the WM task, but no previous spiking model of WM could reproduce them.

To get the results presented in FIGS. 5D and 12, only an initial segment of the target PNG is activated during the selection (cueing) process. Therefore, only the synapses forming the initial segment of the target PNG get temporarily potentiated. Hence, only the neurons in the initial segment of the target PNG get more frequently reactivated as propagation of activation along the PNG dies out somewhere in the middle of the PNG without activating the neurons at the back. As spontaneous reactivations persist, more and more synapses undergo short-term STDP, and more and more neurons from the end of the target PNG start to participate in the reactivations. Activities of such neurons show ramping up firing rates (FIG. 5D n559; see also FIG. 12). Conversely, neurons in the initial segment of the PNG may not participate in enough reactivations and, therefore, synapses to those neurons decay back to their baseline strength, resulting in a ramping down firing profile (n392 FIG. 5D; FIG. 12B). In general, the slowly changing firing rates are generated by spontaneous incomplete activations within the target PNG: Neurons that are initially stimulated exhibit ramping down firing profile. In contrast, those that join just later in the wave of reactivation (FIG. 12E) express ramping up (and later down) firing activity.

Working Memory and Perception of Time

These stereotypical firing rate profiles may be utilized to encode time intervals. For example, a motor neuron circuit that needs to execute a motor action 10 seconds after a GO signal may have strong connections from neurons such as n559 (see FIG. 5D), and be inhibited by the activity of neurons such as n652. Moreover, a sequence of behaviors may be executed by potentiating connections from multiple subsets of the PNG to multiple motor neuron circuits (e.g., via dopamine-modulated STDP). Activations of multiple representations in WM, as illustrated in FIG. 10, may implement multiple timing signals and multiple sequences of actions.

Multiple Cues in Working Memory

In a single network, multiple PNGs, i.e., multiple memories, can be loaded and maintained in WM simultaneously despite large overlap in their neuronal composition. In FIG. 10 two PNGs are stimulated sequentially (out of the thousands available PNGs). The target PNGs include 220 and 191 neurons each, and have 66 neurons in common. The intra-PNG neurons, however, fire with different timings relative to the other neurons within each PNG (FIGS. 10C-10D). Therefore, there is little or no interference, and both PNGs are simultaneously kept in WM for many seconds. The computer model can hold several items in WM but eventually its performance deteriorates with increased load (note the sub-linear histogram in FIG. 10B).

FIG. 6. Maintenance of a Polychronous Neuronal Group in WM with Short-Term Amplification of Synaptic Responses Via NMDA Spikes—One Trial.

Neurons n of the target tPNG (to be loaded into working memory WM) are stimulated with the appropriate spike-timing pattern repeated 10 times, starting at 0 second—similar to the mechanism used in FIG. 5 and FIG. 10. Solid lines: average multiunit firing rate of the target group tPNG (red) and that of the rest of the excitatory neurons (blue). Blue dots, spikes of excitatory neurons; Cyan dots, inhibitory neurons; Red dots, spikes of the neurons belonging to the target group tPNG during (partial) reactivations of the target group, that is, when more than 25% of its neurons n fire with the expected (±15 ms) spatiotemporal pattern. Dark green line, time course of the short-term synaptic decay without spontaneous replay of the target group; time constant is 250 milliseconds.

FIGS. 7A-7C. Increased Plasticity Rate Modulated by Elevated Level of a Simulated Neuromodulator.

(FIG. 7A) Spike raster and firing rate plots during a single working memory WM task/trial. Solid lines: average multiunit firing rate of the target group tPNG (red) and that of the rest of the excitatory neurons (blue). Blue dots, spikes of excitatory neurons n; Cyan dots, inhibitory neurons n; Red dots, spikes of the neurons n belonging to the target tPNG during (partial) reactivations of the target group, that is, when more than 25% of its neurons fire with the expected (±15 ms) spatiotemporal pattern. The target tPNG is shown as being stimulated at 0 second and at 5 second (shading). The brown shaded area starting a little before 5 second (better seen in the subplots of FIGS. 7B and 7C) denotes an elevated simulated neuromodulator level, which results in 5 times faster plasticity change in the network. (FIG. 7B) Data and notation as in FIG. 7A but only neurons n of the target groups tPNG in the [5 . . . 10] second interval are shown. (FIG. 7C) Identical to FIG. 7B, but the plotting of the neurons n is reordered so their polychronous firing is clearly visible as tilted lines.

FIG. 8. Associative Short-Term Synaptic Plasticity Change During Memory Replay.

The spike raster plot (and data) is identical to that shown in FIG. 5A. Overlaid on the spike raster is the short-term change (average of standard deviation), relative to the baseline synaptic values, for the synapses forming the target tPNG (red curves) and for the rest of the excitatory to excitatory synapses (blue curves). The dark green curve denotes the time course of the short-term synaptic decay without spontaneous replay of the target tPNG. The time constant is 5 seconds, but simulations show that the working memory WM replay works in a wide range of parameters.

FIGS. 9A-9E. Working Memory WM Improves the Formation of New PNGs—Novel Cue in WM.

(FIGS. 9A-9C) Spike rasters. Blue color denotes spikes of excitatory neurons, cyan color denotes spike of inhibitory neurons. Red color denotes 60 randomly selected excitatory neurons that received external stimulation with a polychronous pattern 10 times per second every 15 seconds (see arrows).

The polychronous pattern used for stimulation does not correspond to the firing pattern of any of the existing PNGs. Different conditions in FIG. 9A, FIG. 9B, and FIG. 9C: Non-specific noisy minis in FIG. 9A and FIG. 9C have frequency 0.3 Hz; in FIG. 9B, the frequency is 0.1 Hz when sec <75 and 0.3 Hz if sec >75. FIG. 9C, short-term STDP blocked if sec <75. Identical conditions in FIG. 9A, FIG. 9B, and FIG. 9C when sec >75: 0.3 Hz minis and short-term STDP. (FIGS. 9D-9E) Enlarged spike rasters from data presented in FIG. 9A-9B, respectively. Neurons n that became part of the group PNG initiated by the spiking of red neurons are marked black. The emerging new group PNG in (FIG. 9A and FIG. 9D) consisted of 24 (out of 60) red and 118 black neurons. A number, i.e. 36, of the stimulated neurons did not become part of the newly formed PNG due to the lack of appropriate synaptic connections. Approximately 4 Hz replay of the new group PNG in FIG. 9A and FIG. 9D after six stimulations (of red neurons only), but hardly any replay in FIG. 9B and FIG. 9E, and no replay at all in FIG. 9C.

FIGS. 10A-10D. Multiple Overlapping PNGs in Working Memory WM.

(FIG. 10A) Spike raster and firing rate plots as in FIG. 5. The first target tPNG (red) is activated at time 0 seconds; the second target tPNG (black) at time five seconds. The two PNGs co-exist in working memory WM even though they share more than 25% of their neurons. (FIG. 10B) Capacity tested by multiple items in working memory WM: The plot shows the number of randomly selected PNGs stimulated vs. the number of PNGs simultaneously coexisting in working memory WM. (FIG. 10C) Magnified plot of the spike rasters (red/black dots) of partial activation of the red (left) and the black (right) PNGs; Circles denote expected firing of all the neurons forming the red (left) and black (right) PNGs. Only neurons belonging to the red or black PNG are shown. (FIG. 10D) Cross-correlograms (CCG) under different network behaviors/dynamics. Red, left: CCG of two neurons that are part of the red but not the black PNG, when only the red is in working memory WM (1<t<5 sec); Black, middle: CCG of neurons that are part of the black but not the red PNG, when only the black is in working memory WM (spike raster not shown); Right: CCG of two neurons, one from each target tPNG, when both PNGs are in WM (t>6 sec).

FIG. 11. Maintenance of Multiple Representations in Working Memory WM in a Network with 100 Embedded PNGs.

The spike raster shows only excitatory neurons n participating in PNG neuronal groups A₁₃, A₉₂, A₁, and A₂. Activation of each such neuronal group PNG, involving more than 25 percent of its neurons n is marked by spikes of different color. Insets show raster plots corresponding to partial activation of various neuronal groups PNG. Circles show where the spikes are expected, black dots show the actual spikes. The network exhibits spontaneous activity except at 0 seconds (stimulation of the first ten neurons belonging to group A₁) and 10 seconds (stimulation of the first ten neurons belonging to group A₂).

If a few neurons forming the i^{th} PNG, Aᵢ, fire with the appropriate spike-timing, the rest of the neuronal group responds with the corresponding polychronous firing pattern. For example, the left two inserts show spontaneous activation of group A₁₃ and group A₉₂. To select a PNG to be held in working memory WM an appropriate sensory input is activated. For example, at time 0 seconds the first 10 neurons of the sequence A₁ are stimulated with the appropriate timing 10 times per second during the interval of 1 second. (The first four stimulations are not colored as less than 25% of the A₁ neurons were activated.) This stimulation resulted in short-term strengthening of the synaptic connections forming the initial segment of A₁ via short-term STDP, but had little effect on the other synapses. Upon termination of the simulated applied input, the strengthened intra-group connectivity resulted in the spontaneous reactivation of the initial segment of A₁ with the precise timing of spikes (3^{rd} inset), leading often to the activation of the rest of the sequence (marked by red dots). Each such spontaneous reactivation of A₁ results in further strengthening of the synaptic connectivity forming PNG group A₁, thereby maintaining A₁ in the active state for tens of seconds. Such an active maintenance is accomplished without any recurrent excitation. Even though each neuron in PNG group A₁ fires with a precise timing with respect to the other neurons in the PNG, the activity of the neuron looks random.

To illustrate maintenance of multiple memory representations in working memory WM, the initial segment of group A₂ is stimulated with a 10 Hz 1 sec long specific excitatory drive. Even though the neuronal groups A₁ and A₂ partially overlap, the neurons fire with different timings relative to the other neurons within each group, so there is little or no interference, and both representations are kept in working memory WM for many seconds.

FIGS. 12A-12E. Systematically Changing Persistent Firing Rates During Working Memory WM Tasks.

Spike rasters and mean (over several trials) firing rates of neurons n at the beginning (FIG. 12A), middle (FIG. 12B) and the end (FIG. 12C) of the polychronous sequence forming the neuronal group A₁ (see also FIG. 11), and a control neuron (FIG. 12D) not belonging to the PNG. Arrows mark the trigger stimulus. The firing rates of these neurons n have stereotypical profiles that are reproducible from trial to trial (as are often those observed experimentally). Sensory stimuli are used and needed to activate only the initial part of the corresponding PNG (network noise prevents full activation of the sequence), resulting in high firing rate in FIG. 12A, but low initial rates in FIG. 12B and FIG. 12C. Subsequent spontaneous reactivations resulted in stronger synapses and in longer sequences (insets in FIG. 11) leading to the steady increase in the firing rates (FIG. 12B and FIG. 12C lower panel). Often, reactivation starts in the middle of the sequence, thereby strengthening synapses downstream but not affecting synapses upstream of the sequence. Eventually, the synaptic connections forming the initial segment become weaker and that part of the neuronal group PNG stops reactivating, resulting in the decline in the firing rate as seen in FIG. 12A and then in FIG. 12B. (FIG. 12E) Neurons n in group A₁ are sorted according to their relative spike-timing within the polychronous sequence and show a single trial spike raster. A slowly traveling wave (moving hot spot) of increased firing rates is generated by spontaneous incomplete activations within A₁. This wave could provide a timing signal to a separate brain region to execute a behavior or a sequence of behaviors timed to the onset of the trigger stimulus. For example, a motor neuron circuit that needs to execute a motor action 10 seconds after the trigger should have strong connections from neurons 20 through 30 from the neuronal group, but be inhibited by the activity of neurons 1 through 20. A sequence of behaviors could be executed by potentiating connections from multiple subsets of the neuronal group to multiple motorneuron circuits (e.g., via dopamine-modulated STDP). Similarly, activations of multiple representations in short-term memory, as in FIGS. 9A-9D (sec >15) and FIG. 10, would implement multiple clocks and multiple sequences of actions.

### SUMMARY

In summary, after the repertoire of PNGs in the computer simulated network of 1000 neurons was determined, a few PNGs were selected to demonstrate how they can serve to maintain working memory WM, and how this mechanism can account for other related experimental findings. Throughout the computer simulation the network is stimulated with stochastic miniature synaptic potentials (called minis) that generate asynchronous, noisy, spiking activity. Embedded in the noisy spike train are occasional precise spiking patterns corresponding to spontaneous reactivations of PNGs. Since each such PNG has a distinct pattern of stereotypical spatiotemporal (i.e., polychronous) spiking activity, this pattern is used as a template to find the reactivation of the PNG in the spike train.

To initiate sustained neuronal activity that characterizes working memory WM, a PNG is transiently stimulated repeatedly with the polychronous pattern that characterizes the PNG. The red dots in the spike raster shown in FIG. 5A indicate spikes of the selected target tPNG. The initial stimulation of the target tPNG resulted in short-term strengthening of the intragroup synapses via associative short-term plasticity, but had little effect on the other synapses in the network (see FIG. 8). Upon termination of the stimulation, the temporarily facilitated intragroup synapses and the noisy minis resulted in sporadic reactivations of different segments of the target tPNG, often leading to the activation of the rest of the polychronous sequence (seen as red vertical stripes in the raster in FIG. 5A and magnified in FIGS. 5B and 5C). Each such reactivation of the target tPNG triggers further strengthening of its synapses, thereby maintaining the target tPNG in the active state for tens of seconds. The active maintenance of a PNG in working memory WM does not depend on a reverberant/looping circuit, but it emerges as a result of the interplay between non-specific noise (which spontaneously triggers activation of PNGs) and short-term strengthening of the appropriate synapses (that makes the reactivation of the target tPNG more likely). There are frequent gaps of hundreds of milliseconds between spontaneous reactivations of the target tPNG, clearly seen in FIG. 1A, but occasional reactivation is necessary to maintain the PNG in working memory WM. Without the reactivations, the initial short-term strengthening of intragroup synapses decays quickly (see FIG. 8 and FIG. 6, “decay without replay” curves). FIG. 5E shows that almost any of the thousands of emerged PNGs, if stimulated, remained activated for more than ten seconds in working memory WM (average 11±8 seconds).

Since spontaneous reactivations of the target tPNG in working memory WM are stochastic, timing of the spiking activity of each neuron n in a PNG also looks random when considered in isolation. Preserved intragroup timing at the millisecond timescale is, however, maintained during replay, as can be seen in the magnified spike rasters in FIGS. 5B, 10C, and 7C. This distinguishes from prior approaches that posit synchronous or totally asynchronous spiking, and this feature allows for the modeling of the present invention to have a vast repertoire of over-lapping PNGs. Cross-correlograms (CCG) of simulated intragroup neuronal pairs also reveal the precisely timed nature of their spiking activity, as well as the context-dependent changes in functional connectivity linking these neurons: The red CCG in FIG. 5C is recorded while the target tPNG is in working memory WM, and it has a peak around 5 ms, whereas the blue CCG is recorded minutes later, when the PNG is not activated, and it is flat. A similar dependence of CCGs of spiking activity on the behavioral state of the network biased by sensory cues was reported in medial prefrontal neurons.

The average multiunit firing rate of the neurons n forming the target tPNG following activation is around 4 Hz, much higher than that of the rest of the network, which is about 0.3 Hz (see FIG. 5A, red vs. blue solid lines). The average firing rate histograms of most intragroup neurons n show distinct temporal profiles that repeat from trial to trial (see FIG. 5D and FIGS. 12A-12E): Some neurons n only respond to the initial stimulation (FIG. 5D n392); some have ramping or decaying firing rates (n652); whereas others have their peak activity seconds after the stimulus offset (n559). Neurons that are not part of the target tPNG show uniform low firing rate activity across the whole trial (n800). These systematically varying, persistent temporal firing profiles are similar to those observed experimentally in vivo in frontal cortex during the delay period of the working memory WM task, but none of the spiking models WM can reproduce them. These stereotypical firing rate profiles may be utilized to encode time itself. For example, a motor neuron circuit that needs to execute a motor action ten seconds after the trigger might have strong connections from neurons such as n559 in FIG. 5D, and be inhibited by the activity of neurons such as n652. Moreover, a sequence of behaviors could be executed by potentiating connections from multiple subsets of the PNG to multiple motorneuron circuits (e.g., via dopamine modulated STDP). Activations of multiple representations in working memory WM, as illustrated in FIG. 10A-10E, may implement multiple timing signals and multiple sequences of actions.

In a single network of, e.g. 1000 neurons in the simulation being described herein, multiple PNGs, i.e., multiple memories, can be loaded and maintained in working memory WM simultaneously despite large overlap in their neuronal composition. As shown in FIG. 10A, two PNGs are stimulated sequentially. The PNGs consist of 220 and 191 neurons each, and have 66 neurons in common. The intragroup neurons, however, fire with different timings relative to the other neurons within each PNG (see FIG. 10C-10D). Therefore, there is little or no interference, and both PNGs are simultaneously kept in working memory WM for many seconds. This computer model can hold more than two items in working memory WM but eventually its performance deteriorates with increased load (see the sub-linear histogram in FIG. 10B).

In conclusion, a feature of the model of the present invention is that memories are represented by PNGs. Such PNGs are defined by unique sets of synaptic connections with matching axonal conductance delays, and each PNG has a distinct pattern of stereotypical spatiotemporal spiking activity allowing neurons to be simultaneously part of many representations. In realistic simulations of spiking networks a large number of such PNGs appear spontaneously, resulting in a vast memory content that can be further expanded via “mental replay”. Results of simulations are robust with respect to parameters of the model, or to the mechanism of associative short-term change of synaptic efficacies. Multiple memories can be selected and kept in working memory WM simultaneously: Associative short-term changes of synaptic efficacies bias the competition between PNGs and result in frequent spontaneous reactivations of the selected PNGs, which are expressed as short polychronous events with preserved intragroup spike-timings. Consistent with this model, polychronous structures are essential for cognitive functions like working memory WM, and such structures may be the basis for memory replays involving, for example, prefrontal cortex, visual cortex, and hippocampus. Additionally, the model of the present invention makes a testable prediction that changes in functional connectivity (FIGS. 5C and 10D) should be observed experimentally during WM tasks.

### APPENDIX

This section of the specification provides exemplary computer code to implement in a computer system the simulation described above in connection with a network of 1000 neurons. Other parameters would be used in the code for networks of different numbers of neurons.

load(‘groupsetal.mat’);
sd=zeros(N,M); % clear

| | |
|---|---|
| firings=[−D 0]; | % spike timings |
| v = −70*ones(N,1); | % initial values |
| u = 0.2.*v; | % initial values |

```
% params
%
% % comment this if called from fig2_ccg_hist
% iCareF = ‘iCare000.txt’;
% onlyinitialize = false;
% selectgroup = 101;
% somepercent = 1;
% rand(‘seed’,1);
% simlength = 22+1;
% % leave the rest
dispOn = true;
stimtime = 3;
stimlength = 1;
stf = 100;
max_ststdp = 19;
ststdp_modulation = 2;
thalamic_noise_prob = .3;
% sort group according to their length
grplength = zeros(length(groups),1);
for i=1:length(groups)
    fr = groups{i}.firings(:,2);
    grplength(i) = length(fr(fr<=Ne));
end
[gY, gI] = sort(grplength,‘descend’);
grpi = gI(selectgroup);
fprintf(‘Working on group’); for i=1:length(grpi), fprintf(‘%d’,grpi(i));
end; fprintf(‘\n’);
% neurons that do not belong to any of the gppi groups
notgrpe = ones(Ne,1);
% sort the neuron indexec, so that the replayed groups are more visible
randInd = zeros(Ne,1);
for i=1:length(grpi)
    grpt = groups{grpi(i)}.firings(:,1);
    grp = groups{grpi(i)}.firings(:,2);
    grpte = grpt(grp<=Ne);
    grpe = grp(grp<=Ne);
    % remove duplicates
    [Y, I] = sort(grpe);
    nondpi = ones(size(grpe));
    dp = find(diff(grpe(I))==0);
    for k=1:length(dp)
        dpi = find(grpe==grpe(I(dp(k))));  % grpe(dpi) is duplicate
        nondpi(dpi(2:end))=0;
    end
    grpe = grpe(nondpi==1);
    grpte = grpte(nondpi==1);
    notgrpe(grpe) = 0;
    grpstarti = 30 + 250*(i−1);
    grpendi = grpstarti+length(grpe)−1;
    randInd(grpe) = grpstarti:grpendi;
    grpi_somepercent = round(somepercent*length(grpe));
    grps{i} = struct(‘grpe’,grpe, ‘grpte’,grpte, ‘v0’,groups{grpi(i)}.v0,
‘t0’,groups{grpi(i)}.t0, ‘grpi_somepercent’,grpi_somepercent);
end
onetoNe = 1:Ne;
onetoNe(randInd(randInd>0)) = 0;
randInd(randInd==0) = onetoNe(onetoNe>0);
gi = 1;
% what data to save
notgrpleind = find(notgrpe==1);
iCare = [grps{gi}.grpe‘, notgrpleind’];
if onlyinitialize
    return;
end
% sensory input / stimulus pattern
SI = zeros(N,1000);
for st=1:stf:1000
    for t=1:grps{gi}.grpi_somepercent
        SI(grps{gi}.grpe(t), mod(grps{gi}.grpte(t)+st,1000)+1) = 1;
    end
end
% decrease exc -> exc connections
se = s(1:Ne,:);
poste = post(1:Ne,:);
se(poste<=Ne) = se(poste<=Ne)/1.25;
s(1:Ne,:) = se;
% decrease inhibitory -> connections
s(s<0) = s(s<0)/1;
myzeros = find(post>Ne | s<0);  % no modulation for exc->inh and
for inh->exc connections
fid = fopen(iCareF,‘w’);
allfirings = [ ];
for sec=1:simlength
    fprintf(‘sec: %d\n’,sec);
```

| | |
|---|---|
| for t=1:1000 | % simulation of 1 sec |

```
        pause(0);
        I = zeros(N,1);
        % external structured stimulation
        if sec>=stimtime && sec<stimtime+stimlength
            I(SI(:,t)>0) = 1000;
        end
        % random thalamic input
        if rand<thalamic_noise_prob
            I(ceil(N*rand))=20;
        end
```

| | |
|---|---|
| fired = find(v>=30); | % indices of fired neurons |

```
        v(fired)=−65;
        u(fired)=u(fired)+d(fired);
        STDP(fired,t+D)=0.1;
        for k=1:length(fired)
            sd(pre{fired(k)})=sd(pre{fired(k)})+
            STDP(N*t+aux{fired(k)});
        end;
        firings=[firings;t*ones(length(fired),1),fired];
        k=size(firings,1);
        while firings(k,1)>t−D
            del=delays{firings(k,2),t−firings(k,1)+1};
            ind = post(firings(k,2),del);
            % short term stdp: use s*(1+3*sd) instead of s
            if firings(k,2)<=Ne
                I(ind)=I(ind)+ max(0, min(max_ststdp, s(firings(k,2),
del)’.*(1+ststdp_modulation *sd(firings(k,2), del)’)));
            else
                I(ind)=I(ind)+ s(firings(k,2), del)’;
            end
            sd(firings(k,2),del)=sd(firings(k,2),del)−1.2*STDP(ind,
            t+D)’;
            k=k−1;
        end;
```

| | |
|---|---|
| v=v+0.5*((0.04*v+5).*v+140−u+I); | % for numerical |
| v=v+0.5*((0.04*v+5).*v+140−u+I); | % stability time |
| u=u+a.*(0.2*v−u); | % step is 0.5 ms |
| STDP(:,t+D+1)=0.95*STDP(:,t+D); | % tau = 20 ms |

```
        if mod(t,10)==0
            sd=0.998*sd;
            sd(myzeros)=0;
        end
        % print
        for frd=1:length(fired)
            if ~isempty(find(iCare==fired(frd),1,‘first’))
                fprintf(fid,‘%f %d\n’, sec+t/1000, fired(frd));
            end
        end
    end;
    % remove that [−20, 0] from the beginning
    firings = firings(2:end,:);
    allfirings = [allfirings; [firings(:,1)+(sec−1)*1000, firings(:,2)]];
    if dispOn
        fexc = firings(:,2)<=Ne;
        finh = firings(:,2)>Ne;
        figNo = 1;
        if get(0,‘CurrentFigure’)~=figNo
            figure(figNo); clf;
        end
        hold off
        plot(firings(fexc,1),randInd(firings(fexc,2)),‘b.’);
        hold on
        plot(firings(finh,1),firings(finh,2),‘k.’);
        for gei=1:length(grps{gi}.grpe)
            fgi = firings(:,2)==grps{gi}.grpe(gei);
            plot(firings(fgi,1),randInd(firings(fgi,2)),‘r.’);
        end
        xlabel(‘time (ms)’);ylabel(‘neuron number’);
        axis([0 1000 0 N]);
        title(strcat(‘sec: ’, num2str(sec)));
        drawnow;
        % print(‘−djpeg’, strcat(‘fig2_v’,numTOstr(sec,3),‘.jpg’));
    end
    exc_firing_rate = sum(firings(:,2)<Ne)/Ne;
    fprintf(‘exc firing rate = %f\n’, exc_firing_rate);
    STDP(:,1:D+1)=STDP(:,1001:1001+D);
    ind = find(firings(:,1) > 1001−D);
    firings=[−D 0;firings(ind,1)−1000,firings(ind,2)];
    % no long-term plasticity / stdp
    % s(1:Ne,:)=max(0,min(sm,0.01+s(1:Ne,:)+sd(1:Ne,:)));
    % sd=0.9*sd;
end;
fclose(fid);
save(strcat(iCareF(1:end−4),‘_allfirings’), ‘allfirings’);
if ~dispOn
    return
end
% plot them all!
fexc = allfirings(:,2)<=Ne;
finh = allfirings(:,2)>Ne;
figNo = 2;
if get(0,‘CurrentFigure’)~=figNo
    figure(figNo); clf;
end
hold off
plot(allfirings(fexc,1),randInd(allfirings(fexc,2)),‘b.’);
hold on
plot(allfirings(finh,1),allfirings(finh,2),‘k.’);
for gei=1:length(grps{gi}.grpe)
    fgi = allfirings(:,2)==grps{gi}.grpe(gei);
    plot(allfirings(fgi,1),randInd(allfirings(fgi,2)),‘r.’);
end
xlabel(‘time (ms)’);ylabel(‘neuron number’);
axis([0 simlength*1000 0 N]);
title(strcat(‘sec: ’, num2str(sec)));
drawnow;
return
showGroupReplay(allfirings, grps{gi}, notgrpe, Ne, simlength);
% % plot histograms
% figNo = 22;
% if get(0,‘CurrentFigure’)~=figNo
%  figure(figNo);
% end
% clf;
%
% % hist
% res = 10;
% hc = 0:res:simlength*1000;
%
% g1neurons = allfirings(:,2)==grps{1}.grpe(1);
% for i=2:length(grps{1}.grpe)
%  g1neurons = g1neurons | allfirings(:,2)==grps{1}.grpe(i);
% end
% %  g2neurons = allfirings(:,2)==grps{2}.grpe(1);
% % for i=2:length(grps{2}.grpe)
% % g2neurons = g2neurons | allfirings(:,2)==grps{2}.grpe(i);
% % end
% notg = find(notgrpe);
% notgneurons = allfirings(:,2)==notg(1);
% for i=2:length(notg)
%  notgneurons = notgneurons | allfirings(:,2)==notg(i);
% end
%
% hg1 = histc(allfirings(g1neurons,1), hc);
% hg1c = conv(hg1, [1 1 1], ‘same’);
% hg1c = (hg1c / length(grps{1}.grpe)) * (1000/res);
%
%
% % hg2 = histc(allfirings(g2neurons,1), hc);
% % hg2c = conv(hg2, [1 1 1], ‘same’);
% % hg2c = (hg2c / length(grps{2}.grpe)) * (1000/res);
%
% hng = histc(allfirings(notgneurons,1), hc);
% hngc = conv(hng, [1 1 1], ‘same’);
% hngc = (hngc / (Ne-length(grps{1}.grpe))) * (1000/res);
%
% % plot
% plot(hc,hg1c,‘r’,‘LineWidth’,1);
% hold on;
% % plot(hc,hg2c,‘k’,‘LineWidth’,1);
% plot(hc,hngc,‘b’,‘LineWidth’,1);
%
% % axis([0 (simlength−1)*1000 0 max(max(max(hg1c),max(hg2c)),
max(hngc))]);
% axis([0 simlength*1000 0 max(max(hg1c),max(hngc))]);
%
% drawnow;
```

What is claimed is:

1. A computer-implemented method of simulating working memory (WM), comprising:
a) storing memory in a computer and identifying data representing a network of neurons;
b) selecting from the identified network a number of polychronous neuronal groups (PNGs) of the neurons, each of the PNGs having a distinct pattern of spatiotemporal spiking activity allowing the neurons to be a part of multiple PNGs, and in which a given PNG is defined by distinct patterns of synapses amongst the neurons in the given PNG;
c) stimulating the network with first stochastic miniature synaptic potentials to generate an asynchronous, noisy, spiking train of the neurons in the given PNG;
d) detecting an occasional precise spiking pattern that is embedded in the noisy spiking train of the given PNG and that corresponds to spontaneous reactivations of the given PNG; and
e) using the precise spiking pattern as a template to determine the reactivations of the given PNG in the spiking train.
